(19) United States
(12) Patent Application Publication
(10) Pub. No.: US 2005/0100138 A1
(43) Pub. Date: May 12, 2005

(54) Telephone call management

(76) Inventor: Joseph Abraham, Hendon (GB)

Correspondence Address: Joseph Abraham, 26 Elliot Road, Hendon, NW4 3DL, GB

(21) Appl. No.: 10/415,172

(22) PCT Filed: Oct. 25, 2001
(86) PCT No.: PCT/GB01/04735

(30) Foreign Application Priority Data
Oct. 25, 2000 (GB) 0026124.8

(51) Int. Cl. H04M 1/64

(52) U.S. Cl. 379/68; 379/85

(57) ABSTRACT

The present invention provides a telephone call management system for providing a number of useful services to a telephone subscriber. This includes a system providing facility to record a message from a caller which is then played back to a subscriber (called party) before selectively connecting the caller to the subscriber or connecting the caller to a message recording service. The system also provides the capability of contemporaneously playing a message received from the caller to the subscriber. The system also allows the recording of conversation between a caller and the subscriber either automatically or in response to instruction by the user either before, during or after the telephone conversation. The system also provides for the ability to connect to a further telephone during a conversation between a caller and the subscriber.

The present invention relates to telephone call management having particular, but not exclusive, application to automated handling of calls for persons who are often in different locations.

With the advent of mobile telephony an era of personal communication has started in which it is possible to contact a particular person (wherever they may be) rather than a particular fixed location. However, these systems have some drawbacks. The called party may be located somewhere beyond the reach of the relevant wireless network, the batteries of the telephone of the called party may have expired or the called party may have forgotten to carry his or her mobile telephone with them.

The mobile telephone networks generally offer a voice mail or answering-machine type service in which a digital recording is made (should the caller wish to leave a message) which can then be retrieved later by the called party using his or her mobile phone but the flexibility is limited. Also the cost of retrieving messages, particularly when out of the country, can be very high. Consequently, the called party may not be as readily-contactable as he or she might desire.

Users of a manned switchboard will be provided with a receptionist who may screen calls on behalf of the called party but this is not possible with a mobile telephone or a single line. While existing CLI systems allow the number of the calling party to be shown to the called party there are a number of drawbacks with these systems. Firstly, the calling party may withhold his or her number (or it is unavailable due to features not being available on the system or for an international number). Secondly, a number of different people may use the same outgoing number so the called party would not know which of these people was calling and thirdly, the called party may not recognise the calling party's number.

Important business calls may need to be recorded so as to settle arguments later or to keep a record of information that is too detailed to be remembered. While this is possible using a sophisticated PABX or a fixed-line telephone and a recording device it is not possible using a mobile telephone or on a fixed line telephone without recording equipment.

It is an object of the various aspects of the present invention to ameliorate at least some of the above drawbacks.

According to a first aspect of the present invention, there is provided a telephone call management system comprising: means for receiving an incoming call, means for recording an incoming message, means for calling a telephone, means responsive to the telephone being answered to play at least a part of the recorded incoming message, means responsive to a signal from the telephone to effect at least one of recording of a message from the incoming call and a connection between the incoming telephone call and the telephone.

The first aspect of the present invention provides a call manager which allows the called party to listen to a short message from the calling party prior to accepting or declining the call. By allowing the calling party to leave a short message, such as their name, the called party may vet incoming calls even when he or she is using a mobile telephone or a telephone without CLI and so on.

In a preferred embodiment, the called party image remain connected and listen to a message recorded by the calling party after the called party has declined to take the call. The called party may then indicate to the call manager, for example by pressing a particular button on his or her handset, that they wish to accept the call after all. The call manager then provides a full bi-directional connection between the calling party and the called party.

According to a second aspect of the present invention, there is provided a telephone call management system comprising: means for receiving an incoming call, means for calling a telephone, means for determining whether the user of that telephone will decline the incoming call, means responsive to that incoming call being declined to record a message from the incoming call, and means for transmitting that message to the telephone substantially contemporaneously with the recording.

In accordance with the second aspect of the present invention, the preferred feature of the first aspect may be used on its own. In other words, the called party may listen to a message being left by the calling party in a system which is not arranged to take a short message from a calling party prior to calling the called party.

According to a third aspect of the present invention, there is provided a telephone call management system comprising: means for receiving an incoming call, means for calling a telephone, means for connecting the incoming call to the telephone, means for recording signals travelling over this means for connecting, and means responsive to a signal from a user to store that recording.

In this aspect of the invention, the call manager is arranged to record both sides of a telephone conversation between a calling party and the called party as soon as the connection between the parties is established. At any time during the call, the called party may, for example by pressing a button on his telephone keypad, request that the contents of the call be stored. The importance of a conversation may only become apparent at some point later in the call (or possibly even at the end of the call). In these circumstances, that part of the conversation which has already occurred would be lost. In accordance with this aspect of the present invention, the call manager allows the called party to decide that a call should be recorded in its entirety. In a preferred embodiment, the call manager also maintains recording of the call for a finite time period after the cessation of the call. The subscriber (called party) may then communicate with the call manager during that time period to retain a digitally-recorded copy of the call, for example by email. In another preferred embodiment the subscriber is offered the option to retain the recording at the end of the call. He or she can indicate, for example using buttons on the telephone whether they wish a recording to be kept.

According to a fourth aspect of the present invention, there is provided a telephone call management system comprising: means for receiving an incoming call, means for calling a telephone number identified in the incoming call, means for connecting the incoming call with the called telephone, and means for recording signals travelling over that connecting means.

In this aspect of the present invention, the calling party (i.e. the person calling the call managing system) is the call managing system subscriber. Rather than simply dialling the number of the person with whom he or she wishes to speak the subscriber calls the call manager and the call manager connects the subscriber to the called party. By routing his call through the call manager, the calling party (subscriber) may arrange for the conversation to be recorded. The call manager may be arranged to automatically record any calls routed in this manner or it may require the calling party (subscriber) to indicate that he or she wishes to record the outgoing call.

According to a fifth aspect of the present invention there is provided a telephone call management system comprising: means for receiving an incoming call, means for calling a mobile telephone, means for connecting the incoming call to the mobile telephone, means responsive to a signal from the mobile telephone to call a further telephone, and means for establishing a connection between the incoming call and the further telephone.

This aspect of the invention allows the Call Transfer feature of a hard-wired PABX to be implemented using a number of different telephones, particularly mobile telephones.

The present invention can be implemented either in hardware or on software in a programmable computer or a programmable telephone system. Further the present invention can be implemented in a combination of hardware and software. The present invention can also be implemented by a single processing apparatus or a distributed network of processing apparatuses.

Since the present invention can be implemented by software, the present invention encompasses computer code provided to a programmable computer or a programmable telephone system on any suitable carrier medium. The carrier medium can comprise any storage medium such as a floppy disk, a CD ROM, a magnetic device or a programmable memory device, or any transient medium such as any signal e.g. an electrical, optical or microwave signal.

The present invention will now be described, by way of example, with reference to the accompanying drawings in which:

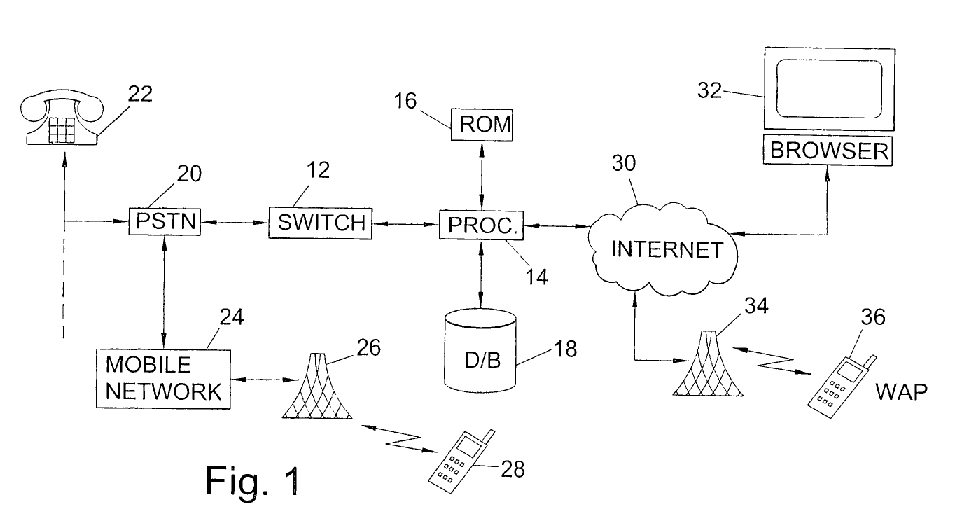

FIG. 1 shows a block schematic diagram of the call manager system;

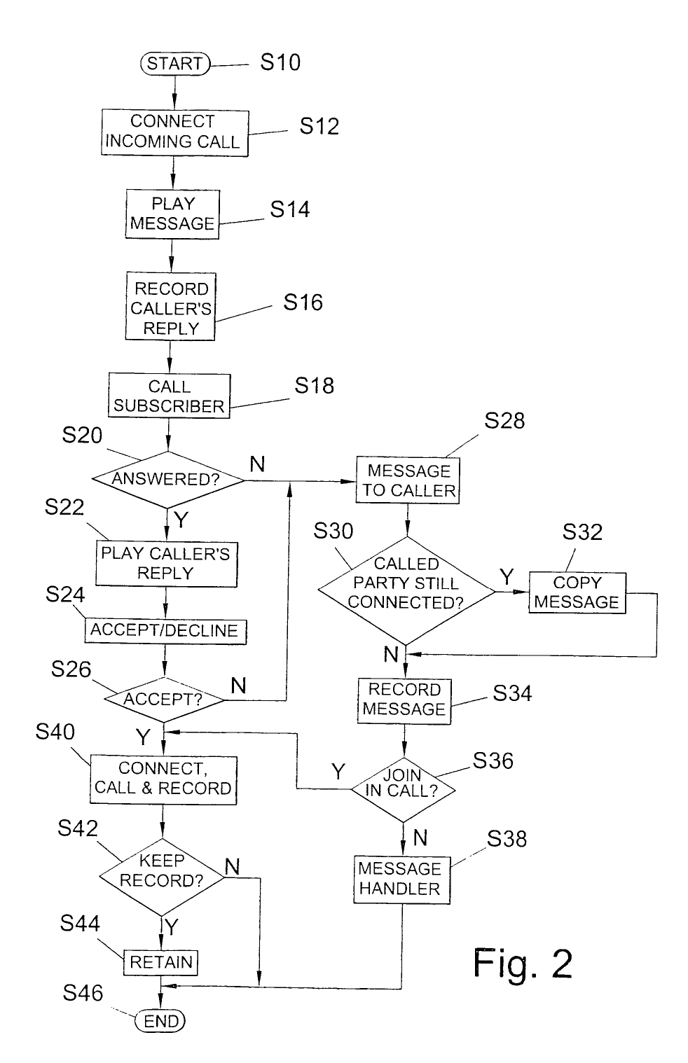

FIG. 2 shows a flow chart of operation of a call manager system according to a first embodiment of the present invention;

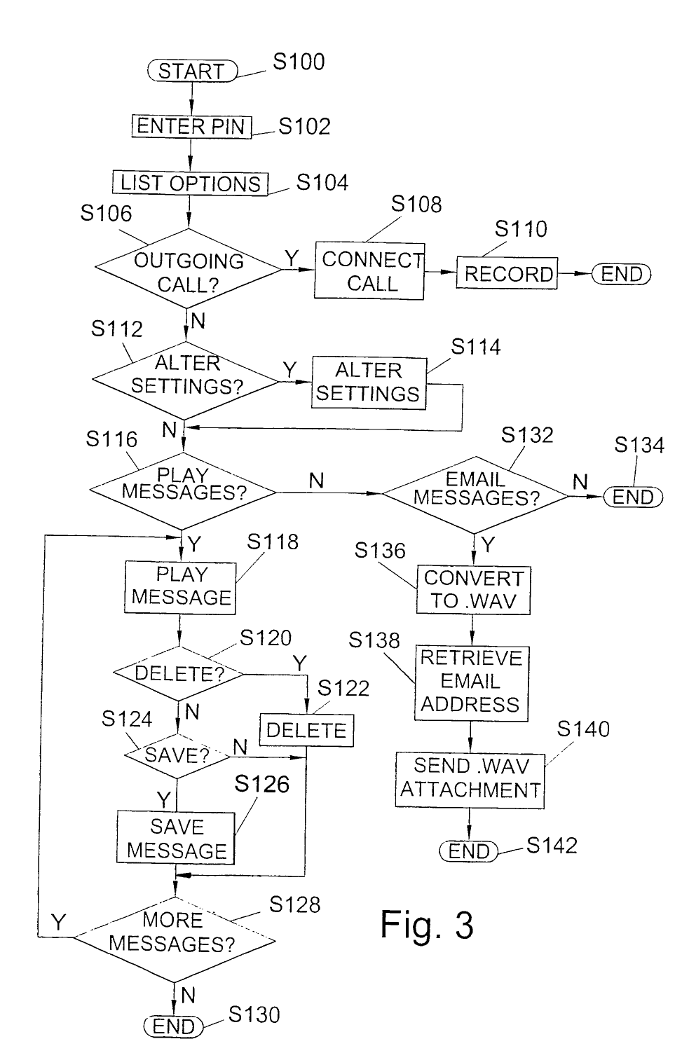

FIG. 3 shows a flow chart of a second embodiment of the invention which may be used in addition to the first embodiment or separately, and

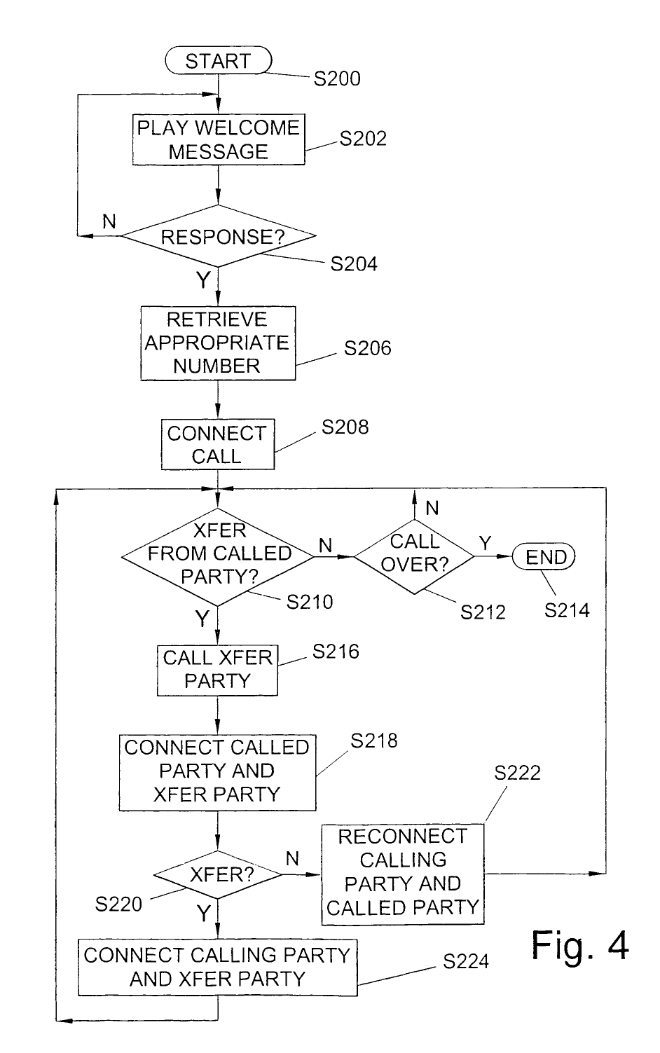

FIG. 4 shows a flow chart of a third embodiment of the invention which may be used in addition to the first and/or the second embodiments or on its own.

FIG. 1 shows a call manager 10 comprising a switch 12 processor 14, read only memory (ROM) 16 and a database (D/B) 18. The switch 12 is connected to the public switched telephone network (PSTN) which in turn connects to a plurality of telephones of which one is shown at 22. The public switched telephone network 20 is also connected to at least one mobile network 24 having a plurality of base stations of which one is shown at 26. The base station 26 is in communication with mobile telephones of which one is shown at 28. The mobile network 24 may be connected directly to the switch 12.

The processor 14 is also connected via the Internet 30 (or other network) to a plurality of browsers of which one is shown at 32. The microprocessor 14 is (at least optionally) programmed to host a website which may be accessed by a user (subscriber) using a browser. This may be used to allow the subscriber to receive digitised voice and facsimile messages and to update personal settings on the call manager. An alternative method of accessing the website is via a wireless application protocol (WAP) enabled mobile telephone 36 in communication with a WAP network 34.

FIG. 2 shows a flow chart of operations performed by the processor 14 (FIG. 1) under control of software stored at the read only memory (16, FIG. 1). In this first embodiment of the invention, a call is re-routed to a called party (subscriber) and allows the called party the option of vetting the call i.e. to decide whether or not to take the call depending on the identity of the calling party. Each subscriber to the call management system has their own telephone number which is unique to them. When the PSTN 20 receives this number the call is routed to the switch 12 (FIG. 1) which “answers” the call. If the call is from a fax machine then the fax message is stored, forwarded to a fax machine and/or converted to a bit-map file and emailed to the subscriber then or at a later date as appropriate. If the call is a voice call then the routine shown in FIG. 2 commences.

At step S10 the routine starts and proceeds to step S12 at which the switch 12 alerts the processor 14 to an incoming call. The processor determines which of the subscribers the call is destined for and retrieves a message from the database 18. The message is played to the caller at step S14. This message is typically one recorded by the subscriber and may be something like “you are through to Mike, please give your name”. At step S16, the reply given by the caller is recorded, in the database 18 (FIG. 1). The caller may be recorded for a fixed time or until silence is detected on the line or other suitable technique or combination of techniques. Once the caller has left a message, the routine proceeds to step S18 at which the subscriber's number is retrieved from the database 18 and the subscriber (called party) is called. In the following description, it is assumed that the subscriber has given a mobile telephone number to the call manager system and it is this number which will be called at step S18. The number could equally relate to a fixed line, be an international phone number and so on. This may be reconfigured by the subscriber, for example by the subscriber ringing up and using a dual tone multi-frequency (DTMF) telephone to inform the system of a new number, by using a WAP-enabled mobile telephone, a PC-based Web browser and so on.

At step S20, the call manager system determines whether the subscriber's telephone has been answered. If the telephone is answered then the processing continues to step S22 at which the caller's reply recorded at step S16 is played to the subscriber. Processing proceeds to step S24 where a message is played to the subscriber such as “press <1> to accept the call or <2> to divert the call to voicemail”. At step S26 the call manager determines whether the subscriber has pressed <1> or <222 , if the subscriber presses <2> then processing proceeds to step S28. This is also the processing step executed if the subscriber does not answer the telephone at step S80. At step S28, a message is played to the calling party such as “your call cannot be connected, if you would like to leave a message please do so after the tone” and a short tone is then played. Processing proceeds to step S30 at which the call manager determines whether the subscriber (called party) is still connected to the call manager. If the subscriber is still connected (or if he explicitly requests that he wishes to listen) then the call manager executes step S32 which arranges for a contemporaneous (or near-contemporaneous) copy of the calling party's message to be played to the subscriber (called party) on his telephone. The subscriber may interrupt the message and commence a conversation with the calling party at any time during the message. He or she may do this by pressing the * key on his or her telephone. At step S34, the call manager records a message and, once the message is complete, a message handling routine is performed which is illustrated at step S38. A number of message-handling techniques may be used either singularly or in combination and so a full description is omitted. As a first option, the message may be stored until the subscriber contacts the call manager system to retrieve his or her messages. Alternatively, or in addition, the message may be e-mailed as a sound file (such as a .WAV file) to an e-mail address specified by the subscriber, a paging message may be initiated to alert the subscriber to the fact that he or she has a recorded message and so on. A number of email addresses may be listed (they may have been previously entered using the call manager Website). The subscriber can select one or more email addresses using any suitable technique such as by pressing buttons on his or her telephone. A convenient method for identifying email addresses over the telephone is to use voice tags. The subscriber may then say, for example, “Simon” or “Office” to the call manager which retrieves the correct email address from the database.

If the subscriber agrees to accept the call at step S26 (for example by pressing 1 on his or her keypad) processing proceeds to step S40 at which the call manager connects the incoming caller to the subscriber and the call may proceed until one or other party hangs up. If the subscriber decides to accept the call during a message being left by the calling party this is detected at step S36 the processing proceeds to step S40.

By way of an optional feature in this aspect of the invention, the call manager also records both sides of the conversation that follows connection of the call at step S40. At any point during the conversation the subscriber can, at step S42, request that a record of the call is retained. If the subscriber selects this option during the call, then step S44 is executed at which a record of the call is retained. It may be automatically emailed to the subscriber. If the subscriber does not select this feature then the recording of the call is deleted (or, more likely, is not explicitly retained and will be overwritten in due course within the database 19). The routine ends at step S46 which is also the step performed following message handling at step S38.

Optionally, where the user has not requested that a recording be kept during the call, the user may be given a prompt at the end of the call such as “Do you want to save this call?” to which the user can reply using phone buttons or voice messages “YES” or “NO” as appropriate.

As a further optional feature, steps S14 and S16 may be disabled by the subscriber and a decision on whether to accept or decline a call made by some other means, such as CLI. When these steps are disabled then step S22 (described below) is also omitted.

FIG. 3 shows a flow chart of the processes executed when the subscriber to the call management system calls that system. The subscriber would call the management system in order to listen to his or her messages which have been recorded but there are also the further, optional features of making an outgoing call, e-mailing the messages to a previously-identified e-mail address or to one or more email addresses identified using voice tags, saving the messages and altering the settings for the subscriber's call manager.

The routine starts at step S100 when the switch 12 informs the processor 14 that a subscriber call has been received. A call from a subscriber (rather than another caller) may be identified by use of a different telephone number. Alternatively, such a call may be identified by entry of a particular code (using a DTMF telephone) on connection to the switch. At step S102 the user is prompted to enter a personal identification number (PIN) and, assuming that the identification is correct, a list of options is given at step S104. Typically, this will list all of the options and the user may select one of the options by pressing a particular number on his or her keypad. For example:
press <1> to listen to your messages.
press <2> to delete your messages.
press <3> to save your messages.
press <4> to e-mail your messages.
press <5> to make a recorded outgoing call.

For simplicity, these options are listed in a consecutive fashion in the flow chart of FIG. 3. However, the skilled person will appreciate that a number of different user-selection techniques may be applied. After step S104, processing proceeds to step S106 at which it is determined whether the user wishes to make an outgoing call. The number to be called may come from the subscriber's favourites list maintained in the database and identified by voice tags, entering numbers on the telephone etc. Alternatively, the number may simply be typed in by the subscriber. If the answer is YES, processing proceeds to step S108 at which the call management system connects the call and, at step S110, records the call for its duration. Processing then proceeds to step S116 which will be discussed more fully below. If it is determined at step S106 that the user does not wish to make an outgoing call, then processing proceeds to step S112 at which it is determined whether the user wishes to alter his settings. These settings might include the number to which telephone calls are diverted, the number to which faxes are diverted, the e-mail address (selected from a previously-supplied list of e-mail addresses) to which sound files are to be forwarded, whether all incoming calls should be diverted to voice mail and so on. If the user does wish to alter settings then processing proceeds to step S114. Any suitable technique for selecting the settings may be employed. Equally, the user may be provided with the option of visiting a website operated by the call management system at which, subject to security procedures, he or she can alter the settings using a more friendly graphical user interface (GUI) than is possible using a telephone. The Website may also give the subscriber access to all of the above functions with a more-easily usable graphical user interface ((GUI).

After step S114 or if the user does not wish to alter his or her settings at step S112, processing proceeds to step S116. At step S116 it is determined whether the user wishes to play his or her messages. If the answer is YES, then processing proceeds to step S118 at which a first stored message is played. As will be apparent to the reader, there are numerous possibilities here such as playing the last message received, playing the first message which has not yet been replayed to the user, providing the user with a list of stored messages from which he or she can select and so on. Any such techniques are encompassed by the present invention and the following description relates only to one straightforward example. After the message is played at step S118, the user is given the option to delete the message at step S120, if the user decides to delete the message then the message is deleted at step S122. Processing then proceeds to step S128. If the user does not wish to delete the message at step S120, then processing proceeds to step S124 at which it is determined whether the user wishes to save the message. If not, then processing proceeds to step S128. If, however, the user does wish to save the message then processing proceeds to step S126 at which the message is saved. Processing then proceeds to step S128 at which the call management system determines whether there are more messages to be played. If the answer is no, then processing proceeds to step S130 at which the routine ends. Otherwise, processing returns to step S118 at which the next message is played.

Recordings of conversations (either incoming or outgoing) will also need to be managed using the same or a similar routine to that used for managing messages. This can be understood by considering the message-handling routine and understanding that “message” includes “recordings”.

If, at step S116, the user does not wish to play his messages then processing proceeds to step S132 at which it is determined whether the user wishes to e-mail the messages. If the answer is NO then processing proceeds to step S134 at which the routine ends. Otherwise processing proceeds to step S136 at which the message or messages are converted to a file suitable for sending by e-mail, for example a .WAV file. Processing proceeds to step S138 at which the e-mail address to which the file or files are to be sent is retrieved from the call manager database. Faxes may also be forwarded in this way. More than one e-mail address may be specified, if desired. Voice tags may be used to allow the subscriber to select one from many email addresses. Once the e-mail address is retrieved, processing proceeds to step S140 at which the .WAV file or files are sent as an attachment to the retrieved e-mail address and the routine finishes at step S142. When the system can determine the caller's telephone number this may conveniently be included in the email.

Access to messages and recordings may be made by visiting a Website hosted by the call manager. This is particularly useful when the subscriber is abroad as the access to the Internet via a browser is likely to be significantly cheaper than calling the call manager directly.

FIG. 4 shows a flow chart for a series of steps performed in accordance with another embodiment of the present invention. This embodiment provides the “call transfer” feature which will be familiar to users of fixed-line private automated branch exchanges (PABX). While this feature is described in the context of an automated telephone exchange for a small business, it will be appreciated that this feature may be used together with either or both of the previously-described embodiments. This aspect of the present invention is, however, particularly applicable to a small firm whose personnel are often away from the main business location (or there is no main business location) but which is not sufficiently large to justify the expense of a full-time receptionist. The example given here is a three-man plumbing company but this feature may be applied to a PABX system that serves a large office, for example.

When a caller connects to the call management system the routine starts at step S200 and processing proceeds to step S202. At step S202 a message is played to the caller such as: “welcome to PB plumbing, please press <1> for general enquiries, <2> for Dave Gorman, <3> for Martin Armstrong or <4> for Derek Coombs. At step S204 it is determined whether the caller has made a response, and if not, the message is replayed at step S202. Alternatively, a lack of response from the caller may automatically be interpreted as a request for general enquiries. If it is assumed that Dave Gorman is the boss of PB Plumbing then general enquiries may be arranged to be passed to him. However, if his telephone, typically a mobile telephone, is busy or unanswered, then general enquiries could be forwarded to Martin Armstrong, and similarly should he be unavailable, to Derek Coombs. It would be appreciated that this arrangement means that there is a very strong chance that a caller will be quickly connected to one of the members of the firm, rather than a voice mail recording system. This should reduce the chance of business being lost through lack of caller satisfaction.

Assuming that the caller has requested to speak to Dave Gorman, the appropriate number (such as a mobile number) is retrieved at step S206. The call management system then proceeds to connect the call at step S208. It should be appreciated that features from the first-described embodiment such as call vetting, picking up a call while a message is being left or recording of a conversation may also be included with this embodiment. In addition, the call transfer feature may be used without the automated PABX features of steps S202 and S204.

After step S208, processing proceeds to step S210 at which it is determined whether the called party wishes to transfer the call. This may be done by, for example, the called party pressing the * button on his or her telephone. If the called party has not requested a transfer, then processing proceeds to step S212 at which it is determined whether the call is over. If not, processing returns to step S210 but, if the call has finished, then the routine ends at step S214. If a transfer has been requested by the called party then processing proceeds to step S216 at which the management system places a call to a transfer party identified by the called party (for example by pressing one of the buttons on his or her telephone or by using voice tags). Assuming that the call is connected processing proceeds to step S218 at which the called party and the transfer party are connected by the call manager. Usually, although not essentially, the calling party will be excluded from this conversation. They may conveniently be played a message or some music to reassure them that they are still connected. The called party and the transfer party can now discuss whether to transfer the call from the called party to the transfer party and this is determined at step S220, for example by the called party pressing the * button on his or her telephone. If the call is to be transferred, then processing proceeds to step S224 at which the calling party and the transfer party are connected. Normally, the called party would then hang up and the call manager would then operate as though the transfer party were the called party and processing proceeds to step S210. Further transfers are then possible.

Once the transfer has been effected at step S224, the original called party may remain connected to the other two parties, effectively providing a “conference call” facility. Alternatively, the original called party may have listen-only access to the following call between the calling party and the transfer party. As a further alternative, the call management system may simply break the connection to the called party (as would happen in a hard-wired PABX). If a transfer is determined not to be required at step S220 then processing proceeds to step S222 at which the calling party and the called party are reconnected. In a similar manner to the techniques available at step S224, the transfer party may remain in contact with the other two parties, may be provided with listen-only access or may be disconnected from the call manager. After step S222, processing returns to step S210 to allow further transfers to occur. Where the three parties remain connected at either step S224 or step S222 then the procedure may be repeated to add further parties to the call. The result is a conference call between a number of telephones such as mobile telephones located at several different sites.

In a fourth embodiment, which may be used in combination with any of the foregoing embodiments in any combination, it is possible to monitor a call or a message using the call manager Website. The call manager, subject to suitable security procedures, allows the subscriber or other authorised person to listen “live” to calls in progress or messages as they are being left. This is useful, for example when an important call needs to be monitored for business or quality control reasons. The user may be provided with a GUI that allows him or her to listen at will to one or more of the lines that are owned by him or her.

Another feature that can be added to any of the foregoing embodiments is reading of email. The call manager system can read out incoming emails to a subscriber when he or she cannot access the emails in any other way. Also a reply may be recorded and then sent to the sender of the email as a voice file attachment. Also an email containing a voicefile can be sent to one of a number of email addresses, for example using voice tags to identify the recipient or recipients (i.e. not necessarily in response to an incoming email).

1. A telephone call management system comprising:
means for receiving an incoming call,
means for calling a telephone,
means for connecting the incoming call to the telephone,
means for recording signals travelling over this means for connecting, and
means responsive to a signal from a user to store that recording.

2. A telephone call management system as claimed in claim 1, wherein the means for storing the recording comprise means for sending the recording to a remote computer.

3. A telephone call management system as claimed in claim 2, wherein the means for sending the recording to a remote computer comprise means for emailing the recording to a remote computer.

4. A telephone call management system as claimed in any one of the claims 1 to 3, wherein the means responsive to a signal from a user comprise means responsive to a signal from the telephone while a call is in progress.

5. A telephone call management system as claimed in any one the claims 1 to 4, further comprising:
means responsive to a signal from the telephone to call a further telephone, and
means for establishing a connection between the incoming call and the further telephone.

6. A telephone call management system comprising:
means for receiving an incoming call,
means for calling a telephone number identified in the incoming call,
means for connecting the incoming call with the called telephone, and
means for recording signals travelling over that connecting means.

7. A telephone call management system as claimed in claim 6, further comprising means for sending the recording of the signals to a remote computer.

8. A telephone call management system as claimed in claim 7, wherein the means for sending the recording to a remote computer comprise means for emailing the recording to a remote computer.

9. A telephone call management system comprising:
means for receiving an incoming call,
means for calling a telephone at a remote location,
means for connecting the incoming call to the telephone,
means responsive to a signal from the telephone to call a further telephone, and
means for establishing a connection between the further telephone and at least one of the incoming call and the telephone.

10. A telephone call management system as claimed in claim 9, further comprising:
means for connecting the telephone and the further telephone before connecting the incoming call and the further telephone.

11. A telephone call management system as claimed in claim 10, wherein the means for connecting the telephone and the further telephone before connecting the further telephone and the incoming call is also arranged to break the connection, at least temporarily, between the incoming call and the telephone.

12. A telephone call management system as claimed in claim 11, further comprising means for playing a signal to the incoming caller when the connection is broken.

13. A telephone call management system as claimed in any one of claims 9 to 12, wherein:
the means responsive to the signal from the telephone are also responsive to a signal from the further telephone to call another telephone and
the means for establishing a connection between the incoming call and the further telephone are arranged, in response to a signal from the further telephone, to establish a connection between the incoming call and the another telephone.

14. A telephone call management system as claimed in any one of the claims 9 to 13, further comprising means for connecting the incoming call to one of a plurality of mobile telephones in response to a signal received in the incoming call.

15. A telephone call management system comprising:
means for receiving an incoming call,
means for calling a telephone,
means for determining whether the user of that telephone will decline the incoming call,
means responsive to that incoming call being declined to record a message from the incoming call, and
means for transmitting that message to the telephone substantially contemporaneously with the recording.

16. A call management system as claimed in claim 15, further comprising means responsive to a signal from that telephone to connect the incoming call to the telephone after the user has declined the incoming.

17. A telephone call management system as claimed in claim 16, further comprising:
means for recording signals travelling over the connection between the incoming telephone call and the telephone; and
means responsive to a signal from the telephone to store that recording.

18. A telephone call management system as claimed in claim 16 or claim 17, further comprising:
means responsive to a signal from the telephone to call a further telephone, and
means for establishing a connection between the incoming call and the further telephone.

19. A telephone call management system comprising:
means for receiving an incoming call,
means for recording an incoming message,
means for calling a telephone,
means responsive to the telephone being answered to play at least a part of the recorded incoming message,
means responsive to a signal from the telephone to effect at least one of recording of a message from the incoming call and a connection between the incoming telephone call and the telephone.

20. A telephone call management system as claimed in claim 19, further comprising means for playing a message from the incoming call to the telephone substantially contemporaneously with the recording.

21. A telephone call management system as claimed in claim 20, further comprising means for connecting the telephone to the incoming call in response to a signal from the telephone while the message is being played.

22. A telephone call management system as claimed in claim 19, claim 20 or claim 21, wherein the means for calling a telephone comprise means for calling a mobile telephone.

23. A telephone call management system as claimed in any one of the claims 19 to 22, further comprising:
means for recording signals travelling over the connection between the incoming telephone call and the telephone; and
means responsive to a signal from the telephone to store that recording.

24. A telephone call management system as claimed in any one the claims 19 to 23, further comprising:
means responsive to a signal from the telephone to call a further telephone, and
means for establishing a connection between the incoming call and the further telephone.

25. A telephone call management system for connecting two or more telephone lines together to allow a call to take place, comprising:
means for hosting a website, and
means for transmitting a call carried by the system to a client of the browser.

26. A telephone call management method comprising:
receiving an incoming call from a caller,
calling a telephone,
providing a connection between the caller and the called telephone,
recording signals travelling over this connection, and
storing the recorded signals in response to a signal received from a user.

27. A telephone call management method as claimed in claim 26, wherein storing the recorded signals comprises sending the recorded signals to a remote computer.

28. A telephone call management method as claimed in claim 27, wherein sending the recorded signals to a remote computer comprises emailing the recorded signals to a remote computer.

29. A telephone call management method as claimed in any one of the claims 26 to 28, wherein receiving a signal from a user comprises receiving a signal from the telephone while a call is in progress.

30. A telephone call management method as claimed in any one the claims 26 to 29, further comprising:
calling a further telephone in response to a signal from the called telephone, and
establishing a connection between the incoming call and the further telephone.

31. A telephone call management method comprising:
receiving an incoming call,
calling a telephone number identified in the incoming call,
forming a connection the incoming call with the called telephone, and
recording signals travelling over that connecting means.

32. A telephone call management method as claimed in claim 31, further comprising sending the recording of the signals to a remote computer.

33. A telephone call management method as claimed in claim 32, wherein sending the recording to a remote computer comprises emailing the recording to a remote computer.

34. A telephone call management method comprising:
receiving an incoming call,
calling a telephone at a remote location,
connection the incoming call to the telephone,
calling a further telephone in response to a signal from the telephone, and
establishing a connection between the further telephone and at least one of the incoming call and the telephone.

35. A telephone call management method as claimed in claim 34, further comprising:
connecting the telephone and the further telephone before connecting the incoming call and the further telephone.

36. A telephone call management method as claimed in claim 35, further comprising breaking the connection, at least temporarily between the incoming call and the telephone.

37. A telephone call management method as claimed in claim 36, further comprising playing a signal to the incoming caller when the connection is broken.

38. A telephone call management method as claimed in any one of claims 34 to 37, further comprising:
calling another telephone in response to a signal from the further telephone and establishing a connection between the incoming call and the another telephone in response to a signal from the further telephone.

39. A telephone call management method as claimed in any one of the claims 34 to 38, further comprising connecting the incoming call to one of a plurality of mobile telephones in response to a signal received in the incoming call.

40. A telephone call management method comprising:
receiving an incoming call,
calling a telephone,
determining whether the user of the telephone will decline the incoming call,
recording a message from the incoming call responsive to the incoming call being declined, and
transmitting that message to the called telephone substantially contemporaneously with the recording.

41. A call management system as method in claim 40, further comprising connecting the incoming call to the called telephone after the user has declined the call in response to a signal from the called telephone.

42. A telephone call management method as claimed in claim 41, further comprising:
recording signals travelling over the connection between the incoming call and the called telephone; and
storing that recording in response to a signal from the called telephone.

43. A telephone call management method as claimed in claim 41 or claim 42, further comprising:
calling a further telephone in response to a signal from the called telephone, and
establishing a connection between the incoming call and the further telephone.

44. A telephone call management method comprising:
receiving an incoming call,
recording an incoming message,
calling a telephone,
playing at least a part of the recorded incoming message in response to the called telephone being answered,
effecting at least one of recording of a message from the incoming call and a connection between the incoming telephone call and the called telephone in response to a signal from the called telephone.

45. A telephone call management method as claimed in claim 44, further comprising playing a message from the incoming call to the called telephone substantially contemporaneously with the recording.

46. A telephone call management method as claimed in claim 45, further comprising connecting the called telephone to the incoming call in response to a signal from the telephone while the message is being played.

47. A telephone call management method as claimed in claim 44, 45 or 46, wherein the called telephone is a mobile telephone.

48. A telephone call management method as claimed in any one of the claims 44 to 47, further comprising:
recording signals travelling over the connection between the incoming telephone call and the called telephone; and
storing that recording in response to a signal from the called telephone.

49. A telephone call management method as claimed in any one the claims 44 to 48, further comprising:
calling a further telephone in response to a signal from the telephone, and
establishing a connection between the incoming call and the further telephone.

50. A programmable telephone system comprising:
a storage device storing processor readable code;
a processor for reading and executing the code stored in the storage device, wherein
the code in the storage device comprises code for controlling the processor to carry out the method of any one of claims 26 to 49.

51. A telephone switch having:
an input terminal receiving a call;
a switch path for connecting said call;
an output terminal connecting the switch path to a telephone; and
a storage device connected to the switch path for storing signals on the switch path in response to a user input.

52. A telephone switch having:
an input terminal receiving a call;
a switch path for connecting said call;
a storage device connected to the switch path for storing signals on the switch path in response to a user input; and
an output terminal for sending signals on the switch path to a telephone substantially contemporaneously.

53. A method of operating a telephone terminal comprising:
receiving a call from a telecommunications switch having a recording function;
sending a signal to the telecommunications switch to request recording of the call for later retrieval; and
terminating the call to cause termination of recording at the telecommunications switch.

54. A method of recording and retrieving a telephone call comprising:
initiating a telephone call;
receiving a user input indicating a desire to record the telephone call;
sending a signal indicative of the desire to record the telephone call;
terminating the call; and
retrieving the recorded telephone call.

55. A carrier medium carrying computer readable instructions for controlling a computer to carry out the method of any one claims 26 to 49.

56. A telephone call management system substantially as described herein with reference to the attached drawings.

57. A telephone call management method substantially as described herein with reference to the attached drawings.

58. A method of operating a telephone terminal substantially as described herein with reference to the attached drawings.
